(19) United States
(12) Patent Application Publication
(10) Pub. No.: US 2019/0387320 A1
(43) Pub. Date: Dec. 19, 2019

(54) AUDIO SIGNAL REPRODUCTION APPARATUS AND REPRODUCTION METHOD, SOUND PICKUP APPARATUS AND SOUND PICKUP METHOD, AND PROGRAM

(71) Applicant: Sony Corporation, Tokyo (JP)

(72) Inventor: Kazuki Sakai, Tokyo (JP)

(73) Assignee: Sony Corporation, Tokyo (JP)

(21) Appl. No.: 16/471,262

(22) PCT Filed: Dec. 14, 2017
(86) PCT No.: PCT/JP2017/044859

§ 371 Date: Jun. 19, 2019

(30) Foreign Application Priority Data
Dec. 28, 2016 (JP) 2016-256730

(51) Int. Cl. H04R 5/04; H04R 3/12

(52) U.S. Cl. CPC H04R 5/04; H04R 2420/07; H04R 2400/01; H04R 3/12

(57) ABSTRACT

The present technology relates to an audio signal reproduction apparatus and a reproduction method, a sound pickup apparatus and a sound pickup method, and a program capable of matching listening timing from individual speakers at a listening position with a simpler configuration.

There is provided an audio signal reproduction apparatus including: a reproduction unit that reproduces an audio signal supplied to a speaker installed to be directed to a listening position; and an adjustment unit that adjusts a delay amount of the audio signal supplied to a target speaker in accordance with an interval of a measurement sound obtained from a picked-up signal with another speaker. The picked-up signal is a measurement sound picked up by a sound pickup apparatus installed at the listening position and is a signal including the measurement sound corresponding to a measurement signal, and the measurement signal is a signal that causes a plurality of speakers installed to be directed to the listening position to output the measurement sound at a predetermined time interval. The present technology can be applied to an audio signal reproduction apparatus such as an AV amplifier device and a wireless speaker.

### TECHNICAL FIELD

The present technology relates to an audio signal reproduction apparatus and a reproduction method, a sound pickup apparatus and a sound pickup method, and a program, and more particularly to a sound reproduction apparatus and a reproduction method, a sound pickup apparatus and a sound pickup method, and a program capable of matching listening timings from individual speakers at a listening position with a simpler configuration.

### BACKGROUND ART

In order to accurately reproduce surround effects produced by the multi-channel audio signal, it is desirable that the distance from a listening position to each of speakers be equidistant.

However, there are physical restrictions in arrangement of a plurality of speakers in a general household due to the shape of the house and the arrangement of furniture, and thus, it is not always possible to arrange the speakers at equidistant positions from the listening position.

Here, there is a disclosed technique in a multi-channel audio reproduction environment, in which test signals are reproduced from a plurality of speakers, and then these test sounds are picked up by a microphone installed at a listening position, and subsequently, timing correction is performed on the basis of deviation between the peaks detected from the picked-up signal so as to match listening timings from individual speakers (refer to Patent Document 1, for example).

Furthermore, there is another disclosed technique, in a multi-channel audio reproduction environment, in which test signals are reproduced from each of speakers, and then, picked up by a microphone, and a positional relationship between the speakers is calculated on the basis of the picked-up signals (refer to Patent Document 2).

### CITATION LIST

### Patent Document

Patent Document 1: Japanese Patent Application Laid-Open No. 2004-166106
Patent Document 2: Japanese Patent Application Laid-Open No. 2006-101248

### SUMMARY OF THE INVENTION

### Problems to be Solved by the Invention

Meanwhile, in the technique disclosed in the above-described documents, a sound corresponding to a signal reproduced from each of speakers is picked up by a microphone located at a listening position and then analysis processing such as distance measurement is performed. In this processing, it is necessary that both the test signal reproduction operation on the speaker side and the sound pickup operation for the picked-up signal on the microphone side be in strict synchronization.

Here, in a case where the reproduction operation on the speaker side and the sound pickup operation on the microphone side are asynchronous operation independent from each other, it is necessary to incorporate a synchronous reproduction/sound pickup mechanism on both the speaker side and the microphone side.

In consideration of these, there has been a demand, in a multi-channel audio reproduction environment, for a technique to match listening timings from the speakers at the listening position with a simpler configuration.

The present technology has been made in view of such a situation, and aims to match listening timings from individual speakers at the listening position with a simpler configuration.

### Solutions to Problems

A first aspect of the present technology is an audio signal reproduction apparatus including: a reproduction unit that reproduces an audio signal supplied to a speaker installed to be directed to a listening position; and an adjustment unit that adjusts a delay amount of the audio signal supplied to a target speaker in accordance with an interval of a measurement sound obtained from a picked-up signal with another speaker, in which the picked-up signal is a measurement sound picked up by a sound pickup apparatus installed at the listening position and is a signal including the measurement sound corresponding to a measurement signal, and the measurement signal is a signal that causes a plurality of speakers installed to be directed to the listening position to output the measurement sound at a predetermined time interval.

A reproduction method and a program according to the first aspect of the present technology are a reproduction method and a program corresponding to the audio signal reproduction apparatus according to the first aspect of the present technology described above.

In the audio signal reproduction apparatus, the reproduction method, and the program according to the first aspect of the present technology, the audio signal supplied to the speaker installed to be directed to the listening position is reproduced, and a delay amount of the audio signal supplied to the target speaker is adjusted in accordance with the interval of the measurement sound obtained from the picked-up signal with the interval with another speaker. Furthermore, the picked-up signal is a measurement sound picked up by the sound pickup apparatus provided at the listening position and is a signal including the measurement sound corresponding to the measurement signal, and the measurement signal is a signal that causes a plurality of speakers installed to be directed to the listening position to output the measurement sound at a predetermined time interval.

A sound pickup apparatus according to a second aspect of the present technology includes a sound pickup unit that picks up a measurement sound corresponding to a measurement signal output from a plurality of speakers installed to be directed to a listening position and obtains a picked-up signal, in which the measurement signal is a signal that causes the plurality of speakers to output the measurement sound at a predetermined time interval, and the picked-up signal is a signal including the measurement sound picked up at the listening position.

A sound pickup method and a program according to the second aspect of the present technology are a sound pickup method and a program corresponding to the sound pickup apparatus according to the second aspect of the present technology described above.

In the sound pickup apparatus, the sound pickup method, and the program according to the second aspect of the present technology, a measurement sound corresponding to the measurement signal output from a plurality of speakers installed to be directed to the listening position is picked up, and a picked-up signal is obtained. Furthermore, the measurement signal is a signal that causes the plurality of speakers to output the measurement sound at a predetermined time interval, and the picked-up signal is a signal including the measurement sound picked up at the listening position.

Note that the audio signal reproduction apparatus according to the first aspect of the present technology or the sound pickup apparatus according to the second aspect of the present technology may be either an independent apparatus or an internal block included in one apparatus.

### Effects of the Invention

According to the first and second aspects of the present technology, it is possible to match the listening timings from individual speakers at the listening positions with a simpler configuration.

Note that effects described herein are non-limiting. The effects may be any effects described in the present disclosure.

### BRIEF DESCRIPTION OF DRAWINGS

FIG. 1 is a diagram illustrating a configuration example of a multi-channel audio system in a case where a plurality of speakers is ideally arranged.

FIG. 2 is a block diagram illustrating a configuration example of a mobile terminal device.

FIG. 3 is a block diagram illustrating a configuration example on the reproduction side at the time of measurement.

FIG. 4 is a flowchart illustrating a flow of measurement processing.

FIG. 5 is a diagram illustrating signal waveforms of signals supplied from the audio signal reproduction apparatus to the individual speakers in time series.

FIG. 6 is a diagram illustrating a signal waveform of a picked-up signal picked up by a mobile terminal device in time series in a case where a speaker is in an ideal arrangement.

FIG. 7 is a flowchart illustrating a flow of measurement signal reproduction processing.

FIG. 8 is a view illustrating a configuration example of a multi-channel audio system in a case where there is a distance difference between speakers.

FIG. 9 is a diagram illustrating a signal waveform of a picked-up signal picked up by a mobile terminal device in time series in a case where there is a distance difference between speakers.

FIG. 10 is a block diagram illustrating a configuration example on the reproduction side at the time of reproduction.

FIG. 11 is a flowchart illustrating a flow of audio signal reproduction processing.

FIG. 12 is a block diagram illustrating a configuration example of a wireless speaker.

FIG. 13 is a view illustrating a configuration example of a wireless speaker system in a case where there is a distance difference between wireless speakers.

FIG. 14 is a diagram illustrating a configuration example of a computer.

### MODE FOR CARRYING OUT THE INVENTION

Hereinafter, embodiments of the present technology will be described with reference to the drawings. Note that the description will be given in the following order.

1. First embodiment: multi-channel audio system

(1) Configuration and operation of each of devices at the time of measurement

(A) In ideal arrangement

(B) Arrangement in a case where there is a distance difference between individual speakers

(2) Configuration and operation of each of devices at the time of reproduction

2. Second embodiment: wireless speaker system

3. Modification

4. Configuration of computer

### 1. First Embodiment

In a first embodiment, a multi-channel audio system to which the present technology is applied will be described. In this multi-channel audio system, the reproduction timing of the audio signal is adjusted in accordance with each of distance differences in a case where the distance from the listening position to each of speakers is not constant so as to achieve a constant listening timing from each of the speakers at the listening position.

In this case, the measurement sound output from the plurality of speakers installed to be directed to a listening position is preliminarily picked up at the listening position at the time of measurement before reproduction of an audio signal, at the listening position, at the time of reproducing the audio signal. This leads to adjustment of the reproduction timing corresponding to the sound pickup result.

Accordingly, the following will first describe a configuration and operation of each of devices at the time of measurement, and then describe a configuration and operation of each of devices at the time of reproduction. Furthermore, the description for the time of measurement will be given using comparison between ideal arrangement in which the distance from the listening position to each of speakers is constant and a case of the arrangement having a distance difference between the speakers.

(1) Configuration and Operation of Each of Devices at the Time of Measurement

(A) in Ideal Arrangement

(Configuration of Multi-Channel Audio System)

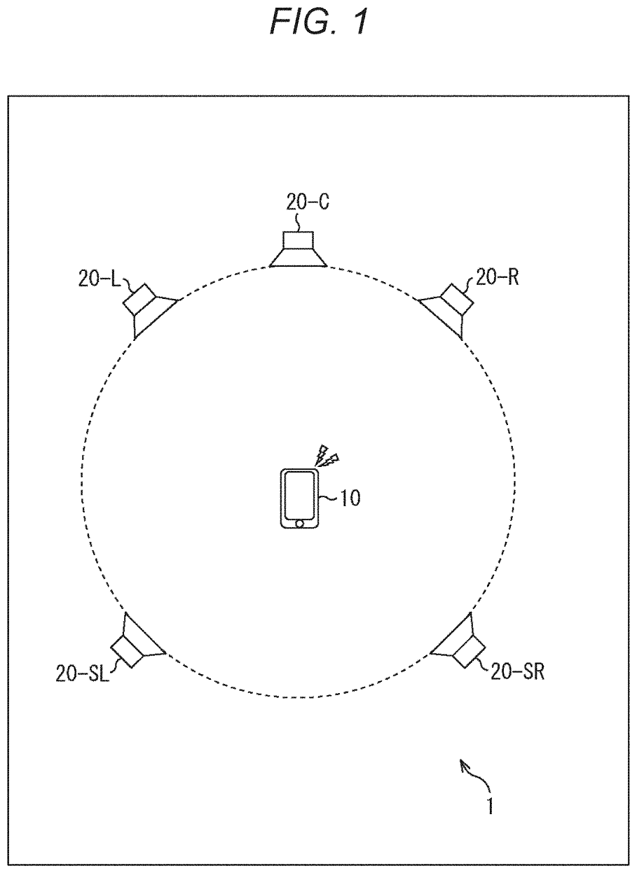

FIG. 1 is a diagram illustrating a configuration example of a multi-channel audio system in a case where a plurality of speakers is ideally arranged.

FIG. 1 is an example of a multi-channel audio system 1 in which a center speaker 20-C, a front L speaker 20-L, a front R speaker 20-R, a surround L speaker 20-SL, and a surround R speaker 20-SR are arranged at ideal positions with respect to a mobile terminal device 10 located at a listening position (listening point).

That is, in the multi-channel audio system 1 of FIG. 1, since each of the speakers 20 is arranged at an ideal position, the distance from the listening position in which the mobile terminal device 10 is positioned to the arrangement position of the speakers 20 is constant as apparent from the relationship with the dotted circle around the listening position in the drawing as a center. Note that, in the following description, the speakers (C, L, R, SL, and SR) included in the multi-channel audio system 1 are simply referred to as the speaker(s) 20 unless particular distinction is necessary.

Examples of the mobile terminal device 10 include a smartphone, a cellular phone, a wireless microphone, a tablet computer, a portable music player, a wearable computer, and a game machine. Note that the mobile terminal device 10 may be a device incorporating a microphone as a sound pickup device (or a device to which an external microphone is attached), and is not limited to a portable device.

At the time of measurement before reproducing the audio signal, the mobile terminal device 10 picks up the measurement sound output from each of the speakers 20 (C, L, R, SL, and SR) at the listening position, and thereby obtains the distance difference between each of the speakers 20. In a case, however, as illustrated in FIG. 1, where each of the speakers 20 is arranged at an ideal position, the distance from the listening position to each of the speakers 20 is constant. Accordingly, there is no distance difference between the speakers 20, and thus, it is not necessary to adjust the reproduction timing corresponding to the distance difference.

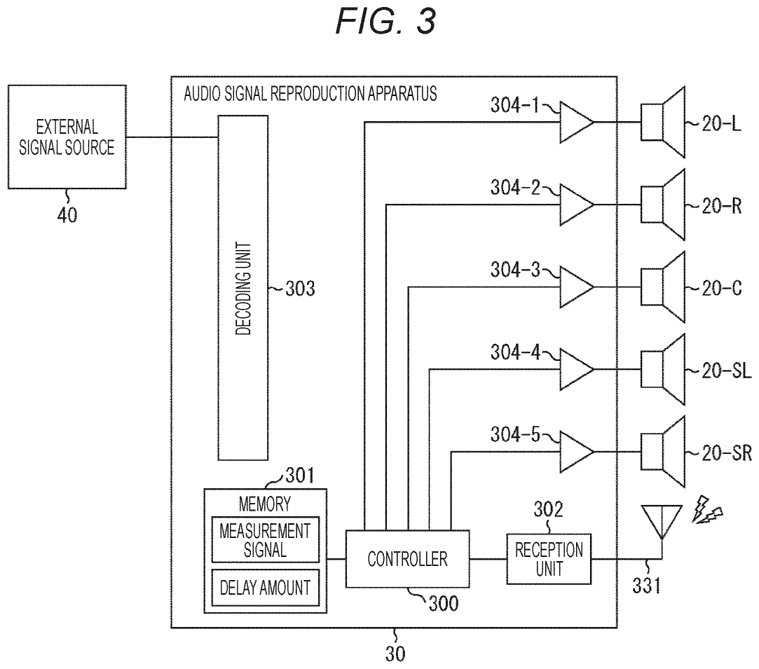

Note that while FIG. 1 omits illustration of an audio signal reproduction apparatus for supplying an audio signal and a measurement signal (test signal) to each of the speakers 20 and an external signal source, the multi-channel audio system 1 includes an audio signal reproduction apparatus 30 (FIG. 3) and an external signal source 40 (FIG. 3) described later.

(Configuration of Mobile Terminal Device)

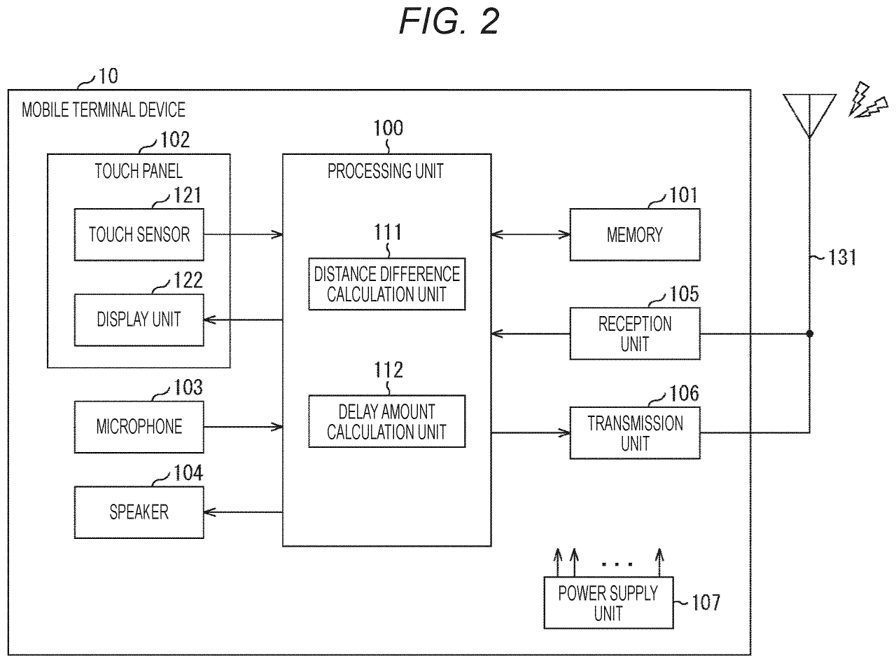

FIG. 2 is a block diagram illustrating a configuration example of the mobile terminal device 10 in FIG. 1.

In FIG. 2, the mobile terminal device 10 includes a processing unit 100, a memory 101, a touch panel 102, a microphone 103, a speaker 104, a reception unit 105, a transmission unit 106, and a power supply unit 107.

The processing unit 100 includes a central processing unit (CPU), a microprocessor, or the like, for example. The processing unit 100 operates as a central processing device, in the mobile terminal device 10, such as device to perform various arithmetic processing and operation control of individual units.

The memory 101 is configured as a semiconductor memory such as a nonvolatile memory (for example, nonvolatile RAM (NVRAM)). The memory 101 stores various data under the control of the processing unit 100.

The touch panel 102 includes a touch sensor 121 and a display unit 122. Note that the touch sensor 121 is superimposed on a screen of the display unit 122.

The touch sensor 121 detects a user's input operation performed on the touch panel 102 (for example, operation of touching a panel surface by user's finger(s)) together with a position on the touch panel 102 where the operation is performed, and then, supplies a detection signal to the processing unit 100.

The display unit 122 includes a display such as liquid crystal or organic EL, for example. The display unit 122 displays various types of information such as images and texts under the control of the processing unit 100.

The microphone 103 is a device (sound pickup device) that converts an external sound into an electric signal. The microphone 103 supplies a signal obtained by the conversion to the processing unit 100.

The speaker 104 outputs a sound corresponding to an electric signal such as an audio signal under the control of the processing unit 100.

The reception unit 105 and the transmission unit 106 are configured as a communication I/F circuit, for example. The reception unit 105 communicates with an external device via an antenna 131, thereby receiving various data and supplying the data to the processing unit 100. The transmission unit 106 communicates with an external device via the antenna 131, and thereby transmits various data from the processing unit 100. Note that the antenna 131 can be built in the mobile terminal device 10.

Note that the communication I/F circuit can implement cellular communication protocols such as long term evolution (LTE), LTE-advanced (LTE-A), 5th generation (5G), and wireless communication protocols such as wireless LAN (also referred to as Wi-Fi (registered trademark)). Furthermore, this communication I/F circuit may implement a short-range wireless communication protocol such as Bluetooth (registered trademark) or near field communication (NFC).

The power supply unit 107 supplies source power obtained from a storage battery or the external power supply to individual units of the mobile terminal device 10 including the processing unit 100.

Here, the processing unit 100 includes a distance difference calculation unit 111 and a delay amount calculation unit 112 for picking up the measurement sound from each of the speakers 20 (C, L, R, SL, and SR) at the time of measurement for calculating the delay amount of each of the speakers 20.

The distance difference calculation unit 111 calculates the distance difference between the individual speakers 20 on the basis of the sound pickup result obtained by picking up the measurement sound from each of the speakers 20. The distance difference calculation unit 111 supplies the calculated distance difference of each of the speakers 20 to the delay amount calculation unit 112.

The delay amount calculation unit 112 calculates the delay amount of each of the speakers 20 on the basis of the distance difference between the speakers 20 from the distance difference calculation unit 111. The delay amount calculation unit 112 supplies the calculated delay amounts of the speakers 20 to the transmission unit 106 as delay data.

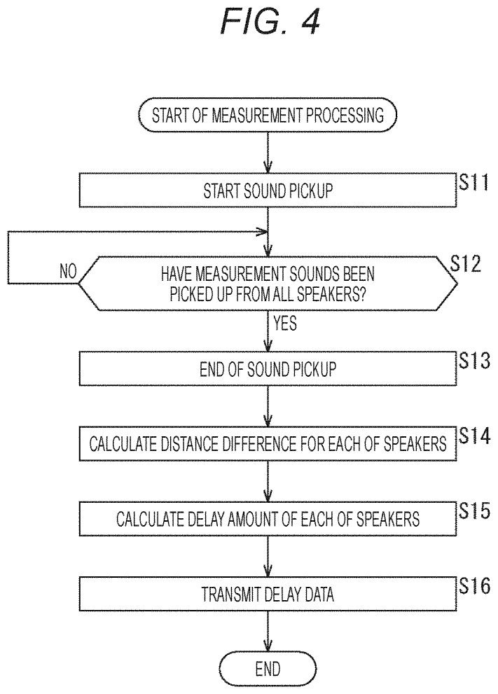

The transmission unit 106 transmits the delay data from the delay amount calculation unit 112 to the audio signal reproduction apparatus 30 (FIG. 3). Note that details of the processing by the distance difference calculation unit 111 and the delay amount calculation unit 112 will be described later with reference to FIG. 4 or the like.

The mobile terminal device 10 is configured as described above.

(Configuration of Device on Reproduction Side at the Time of Measurement)

FIG. 3 is a block diagram illustrating a configuration example of a device on the reproduction side including the speaker 20 (C, L, R, SL, and SR) of FIG. 1.

In FIG. 3, the devices on the reproduction side includes the audio signal reproduction apparatus 30 and the external signal source 40 in addition to the plurality of speakers 20 illustrated in FIG. 1.

The audio signal reproduction apparatus 30 is configured as an AV amplifier device, for example. The audio signal reproduction apparatus 30 includes a controller 300, a memory 301, a reception unit 302, a decoding unit 303, and signal amplifiers 304-1 to 304-5.

The controller 300 is a microcontroller and operates as a central processing device in the audio signal reproduction apparatus 30 that performs various arithmetic processing and operation control of individual units. Note that the controller 300 may be constituted by a CPU, a microprocessor, or the like.

The memory 301 is configured as a semiconductor memory such as a nonvolatile memory, for example. The memory 301 records various types of data under the control of the controller 300.

The reception unit 302 is configured as a communication I/F circuit, for example. The reception unit 302 communicates with an external device via an antenna 331, thereby receiving various data and supplying the data to the controller 300.

Note that this communication I/F circuit can implement various protocols, such as wireless communication protocol including wireless LAN, short distance wireless communication protocol including Bluetooth (registered trademark), cellular communication protocol including LTE, or the like.

The decoding unit 303 decodes an input signal in accordance with a predetermined decoding scheme, and outputs an audio signal obtained as a result.

The signal amplifiers 304-1 to 304-5 amplify input audio signals and supply the amplified signals to the corresponding speakers 20.

The signal amplifier 304-1 is connected to the front L speaker 20-L. The signal amplifier 304-2 is connected to the front R speaker 20-R. The signal amplifier 304-3 is connected to the center speaker 20-C. Furthermore, the signal amplifier 304-4 is connected to the surround L speaker 20-SL, and the signal amplifier 304-5 is connected to the surround R speaker 20-SR.

Here, at the time of measurement, in the audio signal reproduction apparatus 30, the measurement signal recorded in the memory 301 is read out by the controller 300 and supplied to each of the signal amplifiers 304-1 to 304-5.

With this configuration, measurement signals are supplied from each of the signal amplifiers 304 to the front L speaker 20-L, the front R speaker 20-R, the center speaker 20-C, the surround L speaker 20-SL, and the surround R speaker 20-SR. Accordingly, a measurement sound corresponding to the measurement signal is output from each of the speakers 20.

Next, the mobile terminal device 10 arranged at the listening position picks up the measurement sound output from each of the speakers 20, and obtains a delay amount corresponding to the sound pickup result. Delay data corresponding to the delay amount is transmitted from the mobile terminal device 10 to the audio signal reproduction apparatus 30.

In the audio signal reproduction apparatus 30, the reception unit 302 receives delay data from the mobile terminal device 10, and the controller 300 records the delay amount obtained from the delay data in the memory 301.

The device on the reproduction side at the time of measurement is configured as described above.

Next, a flow of processing executed by each of devices at the time of measurement will be described with reference to FIGS. 4 to 7.

(Flow of Measurement Processing)

First, a flow of measurement processing executed by the mobile terminal device 10 will be described with reference to the flowchart of FIG. 4. Note that the mobile terminal device 10 in execution of the measurement processing of FIG. 4 is supposed to be arranged at the listening position and each of the speakers 20 is supposed to be in the ideal arrangement illustrated in FIG. 1.

In step S11, the microphone 103 starts picking up sound.

Here, the mobile terminal device 10 starts picking up sounds using the microphone 103 before starting the reproduction of the measurement sound. The reason is that since the sound pickup operation of the mobile terminal device 10 and the reproduction operation of the audio signal reproduction apparatus 30 are asynchronous, and thus, the mobile terminal device 10 starts sound pickup operation before starting reproduction of the measurement sound in order to reliably pick up a head portion of the measurement signal to be reproduced.

Thereafter, the mobile terminal device 10 instructs the audio signal reproduction apparatus 30 to start reproduction of the measurement signal. This causes the audio signal reproduction apparatus 30 to start reproduction of the measurement signal, and then, a measurement sound corresponding to the measurement signal is output (reproduced) from each of the speakers 20.

In step S12, the processing unit 100 determines whether or not the measurement sound has been picked up from all the speakers 20.

Here, the audio signal reproduction apparatus 30 reproduces the measurement signal, whereby a measurement sound corresponding to the measurement signal is output from the front L speaker 20-L, the front R speaker 20-R, the center speaker 20-C, the surround L speaker 20-SL, and the surround R speaker 20-SR in this order at predetermined time intervals.

Therefore, it is determined, in this determination processing, whether or not measurement sounds have been picked up from the front L speaker 20-L, the front R speaker 20-R, the center speaker 20-C, the surround L speaker 20-SL, and the surround R speaker 20-SR.

In a case where it is determined in step S12 that the measurement sound has not been picked up from all the speakers 20, the sound pickup processing is continued.

In contrast, in a case where it is determined in step S12 that the measurement sound has been picked up from all the speakers 20, the processing proceeds to step S13. In step S13, the microphone 103 terminates the sound pickup.

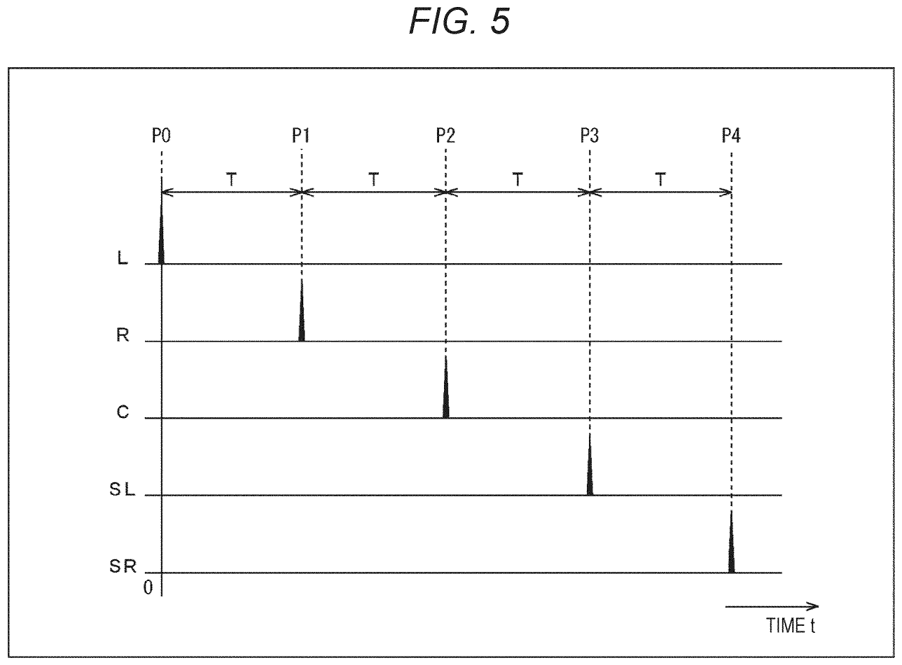

Here, FIG. 5 illustrates an example of signal waveforms of signals supplied from the audio signal reproduction apparatus 30 to the respective speakers 20. Note that L, R, C, SL and SR in FIG. 5 correspond to the arrangement of the speakers 20 illustrated in FIG. 1. Furthermore, note that the time direction is a direction from the left side toward the right side in FIG. 5.

In the audio signal reproduction apparatus 30, the measurement signal is reproduced and measurement sounds corresponding to the measurement signals are output (reproduced) in the order of the front L speaker 20-L, the front R speaker 20-R, the center speaker 20-C, the surround L speaker 20-SL, and the surround R speaker 20-SR at intervals of T seconds. This leads to acquisition of a signal waveform as illustrated in FIG. 5.

That is, if a waveform position P0 of the signal waveform corresponding to the measurement sound from the front L speaker 20-L that first outputs the measurement sound is defined as a reference (assuming time-point 0), then a waveform position P1 of the signal waveform corresponding to the measurement sound from the front R speaker 20-R that next outputs the measurement sound corresponds to a position after the time T seconds from the waveform position P0.

Similarly, a waveform position P2 of the signal waveform corresponding to the measurement sound from the center speaker 20-C corresponds to a position after the time T seconds from the waveform position P1. Similarly, a waveform position P3 of the signal waveform corresponding to the measurement sound from the surround L speaker 20-SL also corresponds to a position after the time T seconds from the waveform position P2. A waveform position P4 of the signal waveform corresponding to the measurement sound from the surround R speaker 20-SR corresponds to a position after the time T seconds from the waveform position P3.

In this manner, the audio signal reproduction apparatus 30 reproduces the measurement signal and thereby supplies a signal corresponding to the measurement signal to each of the speakers 20 at a predetermined time interval (constant interval of time T). Accordingly, the waveform positions P0, P1, P2, P3, and P4 of the signal waveforms corresponding to the measurement sounds output from the individual speakers 20 are positioned at equal intervals (constant intervals) of T seconds.

Note that examples of the usable measurement signal here include an impulse signal that facilitates grasping a waveform position on the time axis, a signal that can be restored to an impulse signal by phase processing on the frequency axis, or the like.

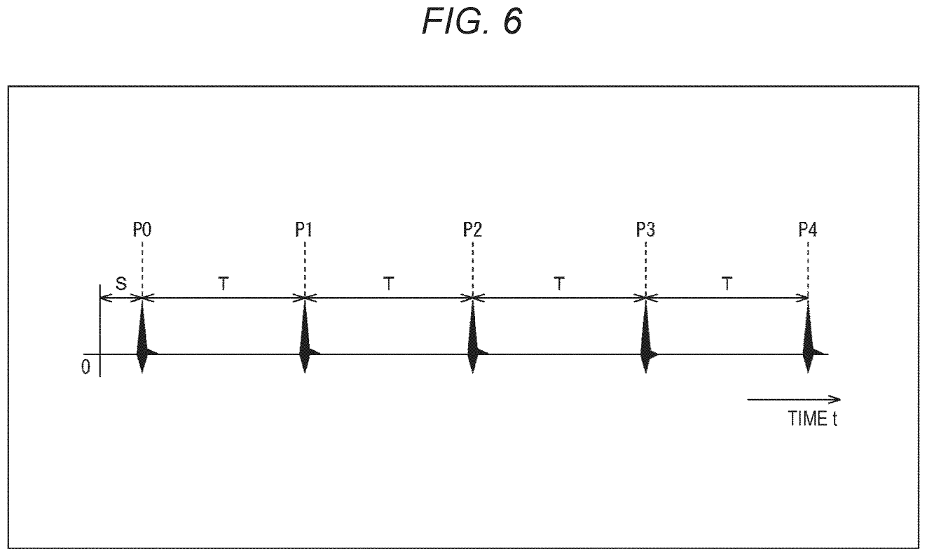

Meanwhile, FIG. 6 illustrates an example of the signal waveform of the picked-up signal (response signal of each of the speakers 20) picked up by the microphone 103 of the mobile terminal device 10. Note that also in FIG. 6, the time direction is a direction from the left side toward the right side in the figure.

In the mobile terminal device 10, picked-up signals corresponding to the measurement sounds are obtained in the order of the front L speaker 20-L, the front R speaker 20-R, the center speaker 20-C, the surround L speaker 20-SL, and the surround R speaker 20-SR by the microphone 103. This leads to acquisition of a signal waveform as illustrated in FIG. 6.

That is, FIG. 6 illustrate a state of sound pickup including picked-up signals, following a leading silent section S, having signal waveforms (peak waveforms) corresponding to measurement sounds output from the speakers 20, at equal intervals of T seconds.

More specifically, if a waveform position P0 of the signal waveform corresponding to the measurement sound from the front L speaker 20-L that first outputs the measurement sound is defined as a reference, then the waveform position P1 of the signal waveform corresponding to the measurement sound from the front R speaker 20-R that next outputs the measurement sound corresponds to the position after the time T seconds from the waveform position P0.

Similarly, a waveform position P2 of the signal waveform corresponding to the measurement sound from the center speaker 20-C corresponds to a position after the time T seconds from the waveform position P1. Similarly, the waveform position P3 of the signal waveform corresponding to the measurement sound from the surround L speaker 20-SL also corresponds to the position after the time T seconds from the waveform position P2. A waveform position P4 of the signal waveform corresponding to the measurement sound from the surround R speaker 20-SR corresponds to the position after the time T seconds from the waveform position P3.

In this manner, in a case where the speakers 20 are arranged at the ideal positions as illustrated in FIG. 1, the distance from the listening position at which the mobile terminal device 10 is arranged to the speakers 20 is constant, and the distance difference between the speakers 20 would be 0. Accordingly, similarly to the signal waveform illustrated in FIG. 5, the signal waveform of the picked-up signal illustrated in FIG. 6 is such that waveform positions P0, P1, P2, P3, and P4 of signal waveforms corresponding to the measurement sound output from each of speakers 20 have equal intervals (constant intervals) of T seconds.

Note that in FIG. 6, the silent section S includes a sound wave propagation time from the front L speaker 20-L to the microphone 103 of the mobile terminal device 10, and further includes a system processing delay time in the mobile terminal device 10 and the audio signal reproduction apparatus 30 from the start of sound pickup by the microphone 103 of the mobile terminal device 10 until a measurement sound is output from the front L speaker 20-L in practice.

Here, sound pickup operation of the mobile terminal device 10 and reproduction operation of the audio signal reproduction apparatus 30 are asynchronous operation in the multi-channel audio system 1. Therefore, their system processing delay times are indefinite, and the silent section S is indefinite as well. In other words, the audio signal reproduction apparatus 30 and the mobile terminal device 10 include no special synchronization mechanism (synchronous reproduction/sound pickup mechanism) in reproduction and pickup of measurement signals.

To cope with this, the multi-channel audio system 1 is configured such that sound pickup is started by the microphone 103 of the mobile terminal device 10, at the time of measurement, before the reproduction of the measurement signal is started by the audio signal reproduction apparatus 30 so as to reliably pick up the head portion of the measurement signal to be reproduced.

Returning to FIG. 4, the distance difference calculation unit 111 calculates in step S14 the distance difference between the individual speakers 20 on the basis of the sound pickup result obtained in the processing of steps S11 to S13.

In this distance difference calculation processing, the distance difference between the individual speakers 20 is calculated from the waveform position of the signal waveform corresponding to the measurement sound from individual speakers 20, in the picked-up signal. For example, here, first, a distance to the front L speaker 20-L on which reproduction is performed first is set as a reference value of the distance difference.

The arrangement of the speaker 20 illustrated in FIG. 1 is an ideal arrangement, in which the distances (relative distances) from the mobile terminal device 10 disposed at the listening position to each of the speakers 20 are the same distance. That is, the distance difference, with respect to the front L speaker 20-L, between the front R speaker 20-R, the center speaker 20-C, the surround L speaker 20-SL, and the surround R speaker 20-SR is all 0.

Therefore, as illustrated in FIG. 6, the waveform positions P0, P1, P2, P3, and P4 of the signal waveforms corresponding to the measurement sounds output from the individual speakers 20 in the picked-up signal have equal intervals of T seconds similarly to the signal waveforms illustrated in FIG. 5.

In step S15, the delay amount calculation unit 112 calculates the delay amount of each of the speakers 20 on the basis of the distance difference obtained in the processing of step S14.

Here, in the case where the arrangement of the speakers 20 is the ideal arrangement illustrated in FIG. 1, the distance difference between the individual speakers 20 is 0, enabling the reproduction timings of the individual speakers 20 to match. Accordingly, the delay amount of each of speakers 20 is 0.

In step S16, the transmission unit 106 transmits delay data corresponding to the delay amount obtained in the processing of step S15 to the audio signal reproduction apparatus 30. However, in a case where the delay amount of each of the speakers 20 becomes 0, the mobile terminal device 10 may choose not to transmit the delay data or notify the audio signal reproduction apparatus 30 of this information.

The flow of the measurement processing has been described above.

(Flow of Measurement Signal Reproduction Processing)

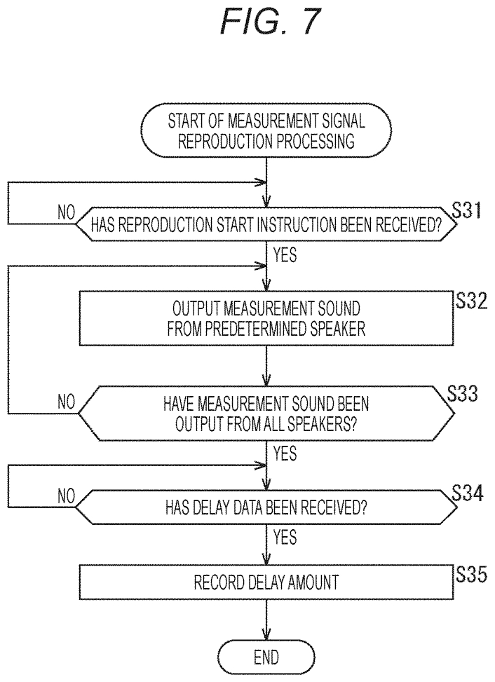

Next, a flow of measurement signal reproduction processing executed by the audio signal reproduction apparatus 30 will be described with reference to the flowchart of FIG. 7.

In step S31, the controller 300 monitors the data received by the reception unit 302 and determines whether or not a reproduction start instruction of the measurement signal has been received from the mobile terminal device 10.

In a case where it is determined in step S31 that the reproduction start instruction of the measurement signal has not been received, the determination processing in step S31 is repeated. In contrast, in a case where it is determined in step S31 that the measurement signal reproduction start instruction has been received, the processing proceeds to step S32.

In step S32, the controller 300 reads out and reproduces the measurement signal recorded in the memory 301, and supplies a signal corresponding to the measurement signal to a predetermined speaker 20, thereby outputting (reproducing) a measurement sound corresponding to the measurement signal from the predetermined speaker 20.

In step S33, the controller 300 determines whether or not the measurement sound has been output from all the speakers 20.

Here, in the audio signal reproduction apparatus 30, the measurement signal read out from the memory 301 is supplied to any of the signal amplifiers 304-1 to 304-5 by the controller 300, whereby a measurement sound corresponding to the measurement signal is output (reproduced) at predetermined time intervals in the order of the front L speaker 20-L, the front R speaker 20-R, the center speaker 20-C, the surround L speaker 20-SL, and the surround R speaker 20-SR.

In a case where it is determined in step S33 that the measurement sounds are not output from all the speakers 20, the processing returns to step S32, and the reproduction processing in step S32 is repeated until the measurement sounds are output from all the speakers 20.

Next, in a case where it is determined in step S33 that the measurement sounds are output from all the speakers 20, the processing proceeds to step S34.

Note that as described with reference to FIG. 5, the audio signal reproduction apparatus 30 reproduces the measurement signal and thereby supplies a signal corresponding to the measurement signal to each of the speakers 20 at a predetermined time interval (constant interval of time T). Accordingly, the waveform positions P0, P1, P2, P3, and P4 of the signal waveforms corresponding to the measurement sounds output from the individual speakers 20 are positioned at equal intervals (constant intervals) of T seconds.

Furthermore, the time interval T of the measurement signal can be set to a value that exceeds the maximum time lag caused by the distance difference from the listening position to the position of each of the speakers 20, for example. At this time, the time taken for the measurement can be obtained by calculating the number of speakers 20×T seconds.

In step S34, the controller 300 monitors data received by the reception unit 302 and thereby determines whether or not delay data corresponding to the delay amount has been received from the mobile terminal device 10.

In a case where it is determined in step S34 that delay data has not been received, the determination processing in step S34 is repeated. In contrast, in a case where the mobile terminal device 10 has executed the processing of step S16 in FIG. 4 and thereby it is determined that the delay data has been received in step S34, the processing proceeds to step S35.

In step S35, the controller 300 records the delay amount obtained from the delay data received from the mobile terminal device 10 in the memory 301.

The flow of the measurement signal reproduction processing has been described above.

(B) Arrangement in a Case where there is a Distance Difference Between Individual Speakers

(Configuration of Multi-Channel Audio System)

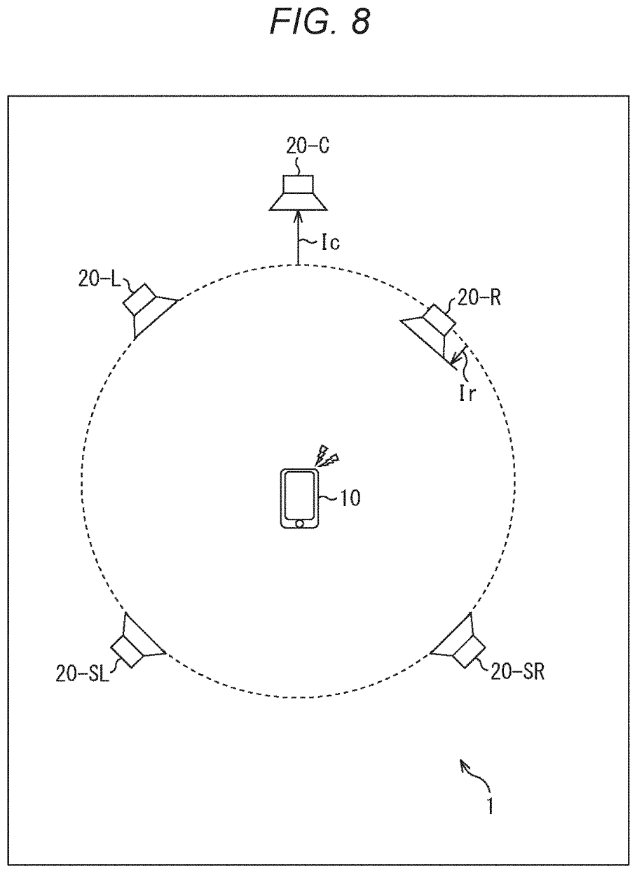

FIG. 8 is a view illustrating a configuration example of a multi-channel audio system in a case where there is a distance difference between the individual speakers.

The arrangement of the speaker 20 illustrated in FIG. 8 is different from the ideal arrangement illustrated in FIG. 1 in that the center speaker 20-C and the front R speaker 20-R are shifted in arrangement positions, having distance differences with respect to the other speakers 20 (L, SL, and SR).

Specifically, as apparent from the relationship of the arrangement positions of the speakers 20 with respect to the dotted circle around the listening position in the figure, the center speaker 20-C is arranged at a farther position by a distance 1c compared with the front L speaker 20-L, while the front R speaker 20-R is arranged at a position closer position by a distance 1r.

(Flow of Measurement Processing)

Execution of the measurement processing of FIG. 4 by the mobile terminal device 10 arranged at the listening position in the case where the distance difference exists between the speakers 20 as described above leads to the following processing result.

That is, in steps S11 to S13 of FIG. 4, the sound pickup processing is continued until the measurement sound has been picked up from all the speakers 20 by the microphone 103, leading to sound pickup of measurement sounds from all the speakers 20.

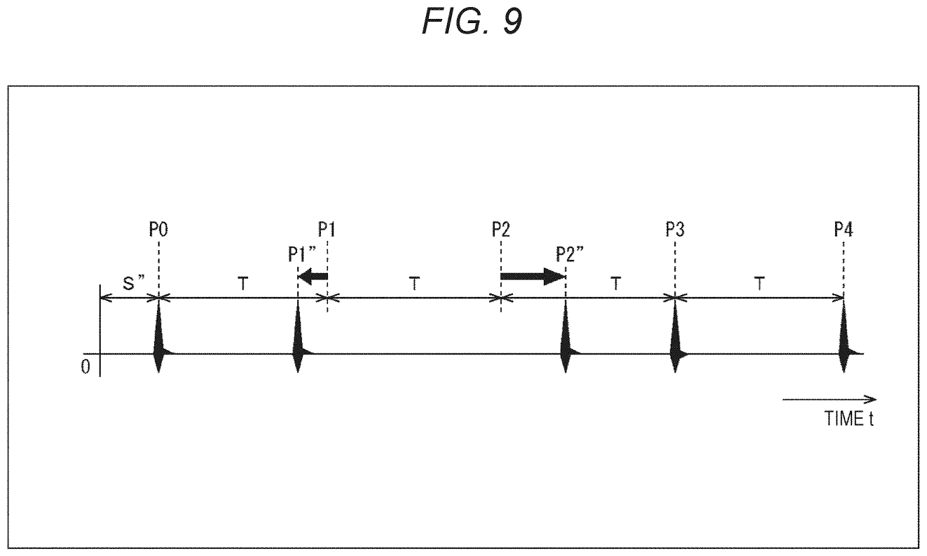

FIG. 9 illustrates an example of the signal waveform of the picked-up signal, which is picked up by the microphone 103 of the mobile terminal device 10 with speaker arrangement illustrated in FIG. 8. Note that also in FIG. 9, the time direction is a direction from the left side toward the right side in the figure.

In FIG. 9, a silent section S″ of an indefinite length and the waveform position P0 of the signal waveform corresponding to the measurement sound from the front L speaker 20-L first appear, and then, a waveform position P1″ of the signal waveform corresponding to the measurement sound from the front R speaker 20-R and a waveform position P2″ of the signal waveform corresponding to the measurement sound from the center speaker 20-C appear.

Here, if focusing on the waveform position P1″ obtained from the measurement sound from the front R speaker 20-R, the waveform position P1″ appears earlier in time than the ideal waveform position P1 (FIG. 6) (indicated by an arrow directed from P1 to P1″ in FIG. 9) by the degree that the arrangement position of the front R speaker 20-R in FIG. 8 is closer to the listening position.

In contrast, if focusing on the waveform position P2″ obtained from the measurement sound from the center speaker 20-C, the waveform position P2″ appears later in time than the ideal waveform position P2 (FIG. 6) (indicated by an arrow directed from P2 to P2″ in FIG. 9) by the degree that the arrangement position of the center speaker 20-C in FIG. 8 is farther from the listening position.

The relationship between these waveform positions and the distance difference can be represented by relationship of the following Formulas (1) to (4) using sound velocity

Vo.

(i) Distance difference (lr) between the front R speaker 20-R and the front L speaker 20-L:

lr=(P1″−P1)×Vo (1)

where P1″<P1 holds in Formula (1). Accordingly, lr is a negative value.

(ii) Distance difference (lc) between the center speaker 20-C and the front L speaker 20-L:

lc=(P2″−P2)×Vo (2)

where P2<P2″ holds in Formula (2). Accordingly, lc is a positive value.

(iii) Distance difference (lsl) between the surround L speaker 20-SL and the front L speaker 20-L:

lsl=0 (3)

(iv) Distance difference (lsr) between the surround R speaker 20-SR and the front L speaker 20-L:

lsr=0 (4)

In step S14 in FIG. 4, the distance difference calculation unit 111 calculates, on the basis of the waveform position of the signal waveform of the picked-up signal illustrated in FIG. 9, that the distance for the front R speaker 20-R is shorter by lr and the distance for the center speaker 20-C is longer by lc, with respect to the distance for the front L speaker 20-L as a reference.

Furthermore, the waveform positions obtained from the measurement sounds from the surround L speaker 20-SL and the surround R speaker 20-SR are the same as the ideal waveform positions P3 and P4 (FIG. 6) respectively. Accordingly, the distance difference from the reference front L speaker 20-L is calculated as 0 for both lsl and lsr.

In step S15 of FIG. 4, the delay amount calculation unit 112 calculates a delay amount necessary to match reproduction timings from each of the speakers 20 at a listening position on the basis of the distance difference of each of the speakers 20 when the position of the front L speaker 20-L is defined as a reference, obtained by calculations in Formulas (1) to (4).

In the arrangement of the speakers 20 illustrated in FIG. 8, the delay amount of each of the speakers 20 can be expressed by the relationship of the following Formulas (5) to (9) with the maximum distance difference lc as a reference. where, Vo represents sound velocity in Formulas (5) to (9) as well.

(i) Delay amount (Dl) of the front L speaker 20-L:

Dl=lc/Vo (5)

(ii) Delay amount (Dr) of the front R speaker 20-R:

Dr=(lc−lr)/Vo (6)

where lr<0 holds in Formula (6).

(iii) Delay amount (Dc) of the center speaker 20-C:

Dc=0 (7)

(iv) Delay amount (Dsl) of the surround L speaker 20-SL:

Dsl=lc/Vo (8)

(v) Delay amount (Dsr) of the surround R speaker 20-SR:

Dsr=lc/Vo (9)

As described above, 0 is calculated as the delay amount for the center speaker 20-C arranged at the farthest position with respect to the listening position, while the maximum delay amount corresponding to the distance obtained by adding up lc and lr is calculated for the front R speaker 20-R arranged at the closest position.

Furthermore, the delay amount corresponding to lc is calculated for the other speakers 20, namely, the front L speaker 20-L, the surround L speaker 20-SL, and the surround R speaker 20-SR.

Subsequently, delay data corresponding to the delay amounts (Dl, Dr, Dc, Dsl, or Dsr) obtained in this manner are transmitted to the audio signal reproduction apparatus (processing of step S16 in FIG. 4).

The flow of the measurement processing has been described above.

(2) Configuration and Operation of Each of Devices at the Time of Reproduction

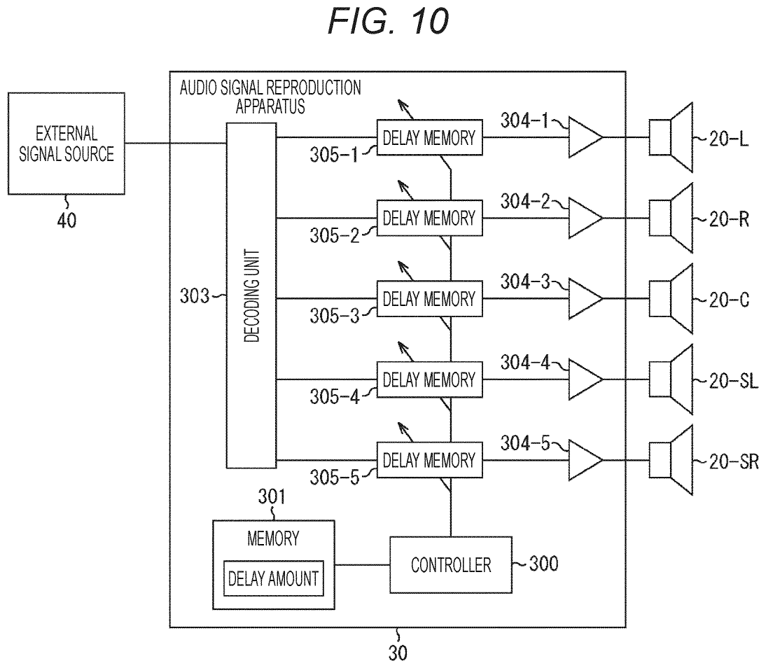

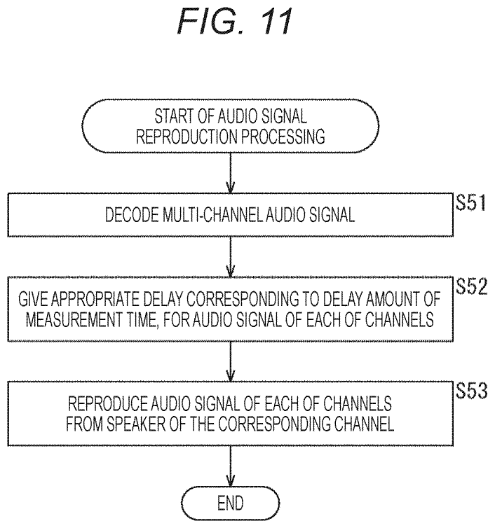

Next, a configuration and operation of each of devices at the time of reproduction will be described with reference to FIGS. 10 and 11.

(Configuration of Reproduction-Side Device at the Time of Reproduction)

FIG. 10 is a block diagram illustrating a configuration example of reproduction-side devices including the speakers 20 (C, L, R, SL, and SR).

In FIG. 10, the devices on the reproduction side includes the audio signal reproduction apparatus 30 and the external signal source 40 in addition to the plurality of speakers 20 similarly to configuration illustrated in FIG. 3.

Furthermore, if comparing the audio signal reproduction apparatus 30 at the time of reproduction in FIG. 10 with the audio signal reproduction apparatus 30 at the time of measurement in FIG. 3, there is a difference that delay memories 305-1 to 305-5 are provided between the decoding unit 303 and the signal amplifiers 304-1 to 304-5.

The controller 300 reads out delay amounts (Dl, Dr, Dc, Dsl, and Dsr) recorded in the memory 301 at the time of measurement and sets these amount respectively onto the delay memories 305-1 to 305-5.

That is, the audio signal reproduction apparatus 30 includes the delay memory 305-1 in upstream of the signal amplifier 304-1 in a system (channel) of the front L speaker 20-L. The controller 300 sets a delay amount (Dl) for the front L speaker 20-L onto the delay memory 305-1.

Furthermore, the delay memory 305-2 is provided in upstream of the signal amplifier 304-2 in a system of the front R speaker 20-R and a delay amount (Dr) is set for the front R speaker 20-R. Similarly, the delay memory 305-3 is provided in upstream of the signal amplifier 304-3 in a system of the center speaker 20-C and a delay amount (Dc) is set for the center speaker 20-C.

Furthermore, the delay memory 305-4 is provided in upstream of the signal amplifier 304-4 in a system of the surround L speaker 20-SL and a delay amount (Dsl) is set for the surround L speaker 20-SL. Similarly, the delay memory 305-5 is provided in upstream of the signal amplifier 304-5 in a system of the surround R speaker 20-SR and a delay amount (Dsr) is set for the surround R speaker 20-SR.

Here, at the time of reproduction, a signal is input from the external signal source 40 to the audio signal reproduction apparatus 30. The external signal source 40 is configured as an optical disc reproduction apparatus such as a digital versatile disc (DVD), for example. A recording signal read out from the optical disc such as a DVD is input to the audio signal reproduction apparatus 30.

In the audio signal reproduction apparatus 30, the decoding unit 303 decodes the signal input from the external signal source 40, and a resulting multi-channel audio signal is delayed in accordance with the delay amount (Dl, Dr, Dc, Dsl, and Dsr) set to each of the delay memories 305-1 to 305-5, respectively, and then, is individually supplied to each of the signal amplifiers 304-1 to 304-5, respectively.

Thereafter, the signals amplified by the signal amplifiers 304-1 to 304-5 are supplied to the front L speaker 20-L, the front R speaker 20-R, the center speaker 20-C, the surround L speaker 20-SL, and the surround R speaker 20-SR, respectively, leading to reproduction of audio signals.

The device on the reproduction side during reproduction is configured as described above.

(Flow of Audio Signal Reproduction Processing)

Next, a flow of audio signal reproduction processing executed by the audio signal reproduction apparatus 30 will be described with reference to the flowchart of FIG. 11. Note that the audio signal reproduction processing of FIG. 11 is executed on condition that the measurement processing of FIG. 4 and the measurement signal reproduction processing of FIG. 7 have already been executed, and the memory 301 preliminarily stores the delay amount of each of the speakers 20 (processing of step S35 in FIG. 7).

In step S51, the decoding unit 303 processes a signal input from the external signal source 40 and decodes the multi-channel audio signal.

In step S52, the delay memories 305-1 to 305-5 give an appropriate delay according to the delay amount of each of the speakers 20 obtained at the time of measurement for each of decoded audio signals of individual channels.

Here, in a case where the positions of the speakers (C, L, R, SL, and SR) are arranged such that there is a distance difference among the speakers illustrated in FIG. 8, for example, the delay amounts (Dl, Dr, Dc, Dsl, and Dsr) corresponding to the distance difference are set in the delay memories 305-1 to 305-5 respectively and delayed for each of audio signals of the individual channels.

Specifically, in the arrangement of the speaker 20 illustrated in FIG. 8 the center speaker 20-C and the front R speaker 20-R are arranged to have a distance difference from the other speakers 20 (L, SL, and SR). Execution of the measurement processing (FIG. 4) and the measurement signal reproduction processing (FIG. 7) described above at time of measurement would lead to acquisition of individual delay amounts (Dl, Dr, Dc, Dsl, and Dsr) of the individual speakers 20, and these amounts are recorded in the memory 301.

That is, the delay amounts Dl, Dr, Dc, Dsl, and Dsr obtained by the above-described Formulas (5) to (9) are recorded in the memory 301 at the time of measurement, and thus, it is possible, at the time of reproduction, to read out the delay amounts Dl, Dr, Dc, Dsl, and Dsr from the memory 301 and set the delay amounts in the delay memories 305-1 to 305-5, respectively.

In step S53, the signal amplifiers 304-1 to 304-5 amplify the signal delayed in accordance with the delay amount, and supply the audio signal of individual channels to the speaker 20 of the corresponding channel. With this procedure, the audio signal of each of channels is reproduced, and sounds corresponding to the audio signal is output (reproduced) from each of the speakers 20.

Here, the delay amount of the center speaker 20-C located at the farthest position is Dc=0, and thus, the delay amount 0 is set in the delay memory 305-1 and an audio signal is to be reproduced without delay in the system (channel) of the center speaker 20-C. Furthermore, the delay amount of the front R speaker 20-R at the closest position is Dr=(lc−lr)/Vo, in the series of the front R speaker 20-R, and thus, an audio signal is reproduced with a delay corresponding to the delay amount.

The delay amounts of the other front L speaker 20-L, the surround L speaker 20-SL, and the surround R speaker 20-SR are all calculated as a value lc/Vo. Accordingly, an audio signal is reproduced with a delay corresponding to the delay amount in each of the front L speaker 20-L, the surround L speaker 20-SL, and the surround R speaker 20-SR.

In this manner, at the time of the measurement before reproducing the audio signal, measurement signals are sequentially reproduced in equal intervals in time sequentially from the individual speakers 20, and then, their measurement sounds are picked up. This enables sequential calculation of the distance difference between each of the speakers 20 and the listening position. Subsequently, at the time of reproducing the audio signal, performing the delay setting corresponding to the distance difference enables adjustment of the reproduction timing of the audio signals. As a result, it is possible to correct the listening timing, enabling the listening timings from each of the speakers 20 to match at the listening position.

Note that, while the above description is an exemplary case mainly regarding the arrangement of the speakers 20 illustrated in FIG. 8, in the case of the ideal arrangement illustrated in FIG. 1, the distance from the listening position to each of the speakers 20 is constant including no distance difference between each of the speakers 20 and the listening position. This enables the listening timings from each of the speakers 20 to match at the listening position even without performing the delay setting in the processing of step S52.

The flow of the audio signal reproduction processing has been described above.

As described above, in the first embodiment, at the time of measurement, the measurement signals at equal intervals are sequentially reproduced from the individual speakers 20, and this enables the mobile terminal device 10 with the built-in microphone 103 to calculate an appropriate delay amount corresponding to the distance difference between each of the speakers 20 and the listening position (relative distance among the speakers 20). Therefore, at the time of reproduction, the audio signal reproduction apparatus 30 performs delay setting corresponding to the distance difference and corrects the listening timing, so as to enable the listening timings from the speakers 20 to match at the listening position.

For example, although there might be cases having physical restrictions in arrangement of a plurality of speakers 20 in a general household due to the shape of the house and the arrangement of furniture, and in a case where it is difficult to make the arrangement positions of the speakers 20 equidistant from the listening position in such a restricted situation, the multi-channel audio system 1 to which the present technology is applied enables the listening timings from the individual speakers 20 to match at the listening position.

Note that the techniques disclosed in the above-described patent documents 1 and 2 uses microphone located at the listening positions and picks up the measurement signals reproduced from the speakers and then, performs analysis processing such as distance measurement. In this, however, the measurement signal reproduction operation on the speaker side and the response signal pickup operation on the microphone side need to be in strict synchronization.

Here, in a case where the microphone disclosed in the above document is replaced with the microphone 103 built in the mobile terminal device 10 such as a smartphone, the reproduction operation on the audio signal reproduction apparatus 30 (speaker 20) side and the sound pickup operation on the mobile terminal device 10 (microphone 103) side would be mutually independent asynchronous operation. Accordingly, it would be necessary to incorporate a synchronous reproduction/sound pickup mechanism (expensive mechanism or complicated mechanism) compatible with wireless operation into both the audio signal reproduction apparatus 30 (speaker 20) and the mobile terminal device 10 (microphone 103).

For this reason, a technique for matching the listening timings from each of speakers at the listening position with a simpler configuration has been demanded, and the present technology makes it possible to meet this demand. That is, the present technology can omit a synchronization mechanism for reproduction and pickup of measurement signals and a microphone dedicated to distance measurement, and instead, the microphone 103 built in the mobile terminal device 10 (for example, a smartphone owned by a user) can be used to enhance convenience.

Note that the term “system” represents a logical set of a plurality of apparatuses. Furthermore, the multi-channel audio system 1 can also be defined as a sound field correction system enabling the listening timings from each of the speakers 20 to match at the listening position.

### 2. Second Embodiment

Meanwhile, the first embodiment is an exemplary case where the measurement signal used at the time of measurement is recorded in the memory 301 (FIG. 3) of the audio signal reproduction apparatus 30. Alternatively, however, the measurement signal can be recorded in the memory 101 (FIG. 2) of the mobile terminal device 10.

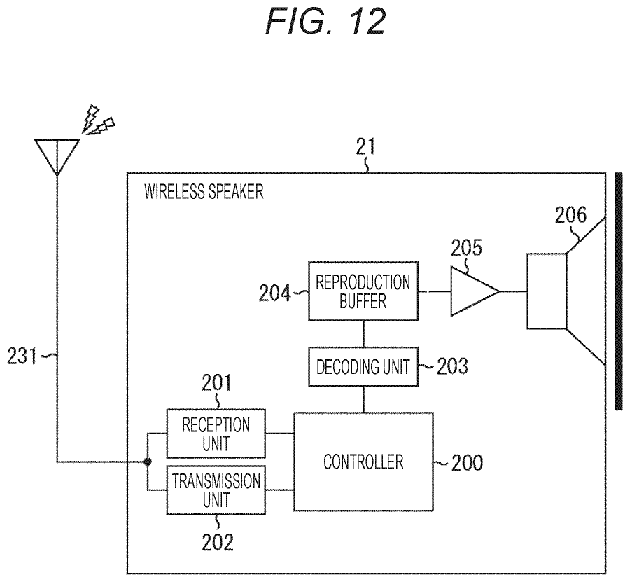

Furthermore, while the apparatus on the reproduction side illustrated in FIG. 3 or FIG. 10 has a configuration in which the plurality of speakers 20 is attached to a single audio signal reproduction apparatus 30, it is also possible to arrange the speakers 20 independently, and may be configured as a wireless speaker 21 as illustrated in FIG. 12.

(Configuration of Wireless Speaker)

In FIG. 12, the wireless speaker 21 includes a controller 200, a reception unit 201, a transmission unit 202, a decoding unit 203, a reproduction buffer 204, a signal amplifier 205, and a speaker unit 206.

The controller 200 is a microcontroller and operates as a central processing device in the wireless speaker 21 to perform various arithmetic processing and operation control of each of units. Note that the controller 200 may be constituted by a CPU, a microprocessor, or the like.

The reception unit 201 and the transmission unit 202 are configured as a communication I/F circuit, for example. The reception unit 201 communicates with an external device via an antenna 231, thereby receiving various data and supplying the data to the controller 200. The transmission unit 202 communicates with an external device via the antenna 231 and thereby transmits various data from the controller 200.

Note that this communication I/F circuit can implement various protocols, such as wireless communication protocol including wireless LAN, short distance wireless communication protocol including Bluetooth (registered trademark), cellular communication protocol including LTE, or the like.

The decoding unit 203 decodes an input signal in accordance with a predetermined decoding scheme, and outputs an audio signal obtained as a result. The reproduction buffer 204 buffers the decoded audio signal and supplies the signal to the signal amplifier 205.

The signal amplifier 205 amplifies the input audio signal and supplies the amplified signal to the speaker unit 206. The speaker unit 206 outputs (reproduces) sound corresponding to the audio signal amplified by the signal amplifier 205.

The wireless speaker 21 is configured as described above.

Note that the wireless speaker 21 not merely receives audio signals and commands from the mobile terminal device 10, but also exchanges control signals or the like for reproduction synchronization with other wireless speakers mutually via wireless communication, so as to achieve a synchronous reproduction mechanism between wireless speakers.

(Configuration of Wireless Speaker System)

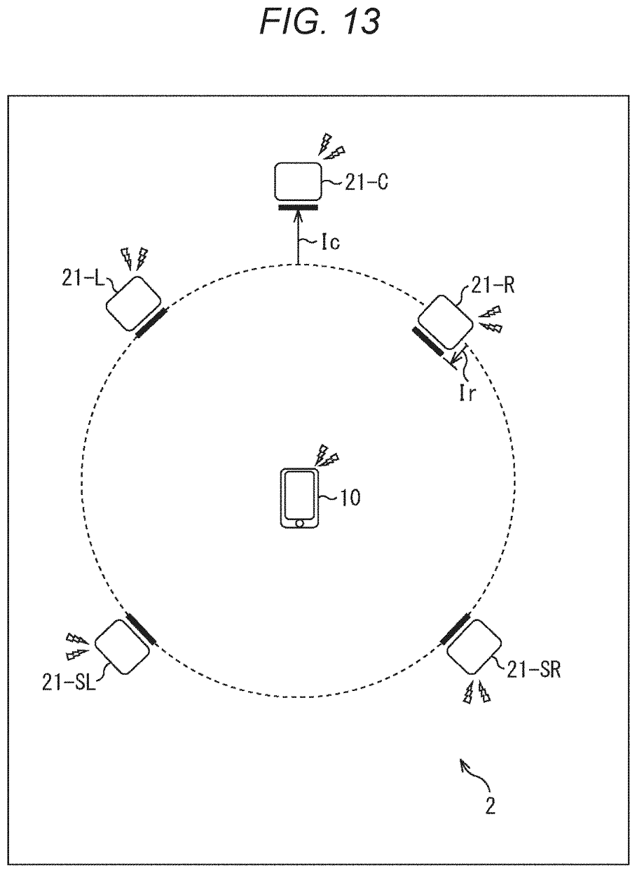

FIG. 13 is a view illustrating a configuration example of a wireless speaker system in a case where there is a distance difference between wireless speakers.

FIG. 13 is an example of a wireless speaker system 2 in which a center wireless speaker 21-C, a front L wireless speaker 21-L, a front R wireless speaker 21-R, a surround L wireless speaker 21-SL, and a surround R wireless speaker 21-SR are arranged with respect to the mobile terminal device 10 located at a listening position (listening point).

Similarly to the arrangement of the speaker 20 illustrated in FIG. 8, the arrangement of the wireless speaker 21 illustrated in FIG. 13 is such that the arrangement positions of the center wireless speaker 21-C and the front R wireless speaker 21-R are shifted, having distance differences with respect to the other speakers 21 (L, SL, and SR).

Specifically, as apparent from the relationship of the arrangement positions of the wireless speakers 21 with respect to the dotted circle around the listening position in the figure, the center wireless speaker 21-C is arranged at a farther position by a distance lc compared with the front L wireless speaker 21-L, while the front R wireless speaker 21-R is arranged at a position closer position by a distance lr.

Here, at the time of measurement, in the mobile terminal device 10 disposed at the listening position, the measurement signal recorded in the memory 101 is read out and transmitted by the transmission unit 106 to each of the center wireless speaker 21-C, the front L wireless speaker 21-L, the front R wireless speaker 21-R, the surround L wireless speaker 21-SL, and the surround R wireless speaker 21-SR.

That is, here, a signal having a waveform similar to the signal waveform illustrated in FIG. 5 is transmitted from the mobile terminal device 10 to each of the wireless speakers 21. This enables the measurement sound corresponding to the measurement signal to be output (reproduced) from each of the wireless speakers 21, and thus, the measurement sound from each of the wireless speakers 21 is picked up by the mobile terminal device 10 disposed at the listening position.

Here, arrangement of the wireless speaker 21 illustrated in FIG. 13 is similar to the arrangement of the speaker 20 illustrated in FIG. 8, and thus, a picked-up signal similar to the signal waveform illustrated in FIG. 9 is obtained. Accordingly, that the mobile terminal device 10 obtains the delay amount of each of the wireless speakers 21 and transmits the amount to each of the wireless speaker 21 similarly to the above-described first embodiment.

For example, calculation of the above-described Formula (5) to (9) leads to acquisition of the delay amounts Dl, Dr, Dc, Dsl, and Dsr for the front L wireless speaker 21-L, the front R wireless speaker 21-R, the center wireless speaker 21-C, the surround L wireless speaker 21-SL, and the surround R wireless speaker 21-SR, respectively.

Then, in each of the wireless speakers 21, delay data (delay amount) from the mobile terminal device 10 is received by the reception unit 201, the decoding unit 203 and the reproduction buffer 204 are controlled by the controller 200, and the delay amount is to be set appropriately for the audio signal. As a result, in each of the wireless speakers 21, the reproduction timing of the audio signal is adjusted (listening timing is corrected), enabling the listening timings from individual wireless speakers 21 to match at the listening position.

Note that the audio signal reproduced by each of the wireless speakers 21 may be provided from the external signal source 40 such as an optical disc reproduction device using wireless communication such as wireless LAN or Bluetooth (registered trademark), or may be audio signals of downloaded music or audio signals of music being reproduced in streaming on the mobile terminal device 10.

As described above, in the second embodiment, at the time of measurement, the measurement signals at equal intervals are sequentially reproduced from the individual wireless speakers 21, and this enables the mobile terminal device 10 with the built-in microphone 103 to calculate an appropriate delay amount corresponding to the distance difference between each of the wireless speakers 21 and the listening position. Therefore, at the time of reproduction, the wireless speaker 21 performs delay setting corresponding to the distance difference and corrects the listening timing, enabling the listening timings from the wireless speakers 21 to match at the listening position.

### 3. Modification

(Setting of time interval T of measurement signal) The above description is an example in which the time interval T of the measurement signal illustrated in FIG. 5 can be set to a value that exceeds the maximum time lag caused by the distance difference from the listening position to the position of each of the speakers 20 (wireless speaker 21). Alternatively, however, in a case where the maximum value of the distance difference can be estimated (predicted) at the time of the second or subsequent measurement or beforehand, a time interval slightly exceeding the estimated value (predicted value) can be set as the time interval T. As a result, the time taken for the measurement can be reduced.

Furthermore, the time interval T need not have a same value for all the speakers 20 (wireless speakers 21). Values corresponding to the assumed distance difference of each of the speakers 20 (wireless speakers 21) may be individually set.

(Number of Surround Channels)

While the above description is an exemplary case having five channels (C, L, R, SL, and SR) as surround channels, the present technology can be applied to a case of other number of channels such as 7ch, 9ch, 5.1ch, 7.1ch, or 9.1ch in a similar manner. Furthermore, the present technology can be applied similarly even in the case of stereo of 2.0ch.

That is, even in a case where the number of channels increases or decreases to the other number of channels, it would be possible, similarly to the case of the above-described five channels, to continuously and sequentially reproduce measurement signals at equal intervals from the speakers 20 (wireless speakers 21) having the number same as the number of channels. This makes it possible to obtain an appropriate delay amount corresponding to the distance difference between each of the speakers 20 (wireless speakers 21) and the listening position.

Therefore, at the time of reproduction, the audio signal reproduction apparatus 30 (wireless speaker 21) performs delay setting corresponding to the distance difference and corrects the listening timing, enabling the listening timings from each of the speakers 20 (wireless speakers 21) to match at the listening position.

Furthermore, the location in which the plurality of speakers 20 (the wireless speaker 21) are arranged is not limited to the home (user's house), and may be installed in a location as long as it is a space capable of arranging the plurality of speakers 20 (wireless speakers 21), including in a vehicle, for example. That is, the present technology enables the listening timings from each of the speakers 20 to match at the listening position even in a case where there are physical restrictions in arranging the speaker 20, making it possible to arrange the speaker 20 even in a space with a physical restriction.

### Other Configuration Examples

In the above description, the distance difference between the speakers 20 is calculated by the mobile terminal device 10 placed at the listening position, and the delay amount of each of speakers 20 is calculated from the distance difference. Alternatively, however, the difference and delay amount may be calculated on the audio signal reproduction apparatus 30 side. In this case, the audio signal reproduction apparatus 30 (FIG. 3) includes the distance difference calculation unit 111 (FIG. 2) and the delay amount calculation unit 112 (FIG. 2).

Moreover, at the time of measurement, picked-up sound data (picked-up signal) itself is transmitted from the mobile terminal device 10 to the audio signal reproduction apparatus 30. In the audio signal reproduction apparatus 30, the distance difference calculation unit 111 calculates the distance difference of each of the speakers 20, and furthermore, the delay amount calculation unit 112 calculates the delay amount of each of the speakers 20.

Note that the distance difference and the delay amount of each of the speakers 20 (wireless speaker 21) may be calculated by a server installed on a network such as the Internet, for example. In this case, at the time of measurement, the mobile terminal device 10 transmits the picked-up sound data itself to the server on the network, and then, the server calculates the distance difference and the delay amount of each of the speakers 20 on the basis of the picked-up sound data. Thereafter, the server transmits the calculated delay amount to the audio signal reproduction apparatus 30 (each of the wireless speakers 21) via the network.

(Adjustment of Level and Frequency Characteristics)

In the above description, the delay amount of each of the speakers 20 (wireless speakers 21) is obtained using the signal waveform of the picked-up signal (FIGS. 6 and 9). Alternatively, however, information obtained from the signal waveform of the picked-up signal may be used to adjust the level or the frequency characteristic of the audio signal. With this configuration, it is not only enables the listening timings from each of the speakers 20 (wireless speakers 21) to match at the listening position, but also enables the user to listen to the sound further optimized.

### 4. Configuration of Computer

The above-described series of processing (for example, the measurement processing in FIG. 4, the measurement signal reproduction processing in FIG. 7, or the audio signal reproduction processing in FIG. 11) can be executed by hardware or software. In a case where the series of processing is executed with software, a program included in the software is installed in a computer. Herein, the computer includes, for example, a computer incorporated in a dedicated hardware, and a general-purpose personal computer that can execute various types of functions with installation of various programs.

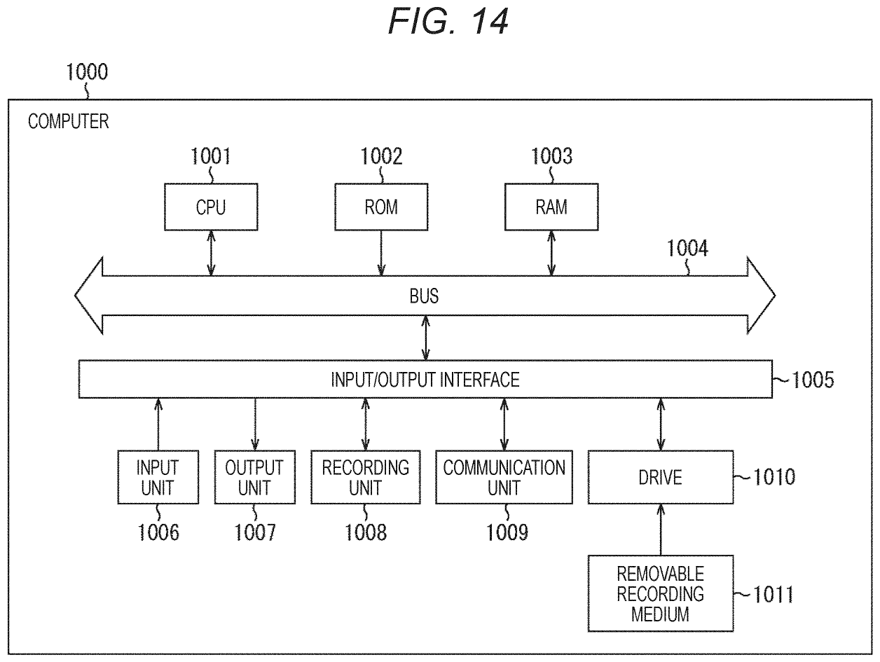

FIG. 14 is a block diagram illustrating a configuration example of hardware of a computer that executes the series of processing described above by a program.

In a computer 1000, a central processing unit (CPU) 1001, a read only memory (ROM) 1002, and a random access memory (RAM) 1003 are interconnected via a bus 1004. The bus 1004 is further connected with an input/output interface 1005. The input/output interface 1005 is connected with an input unit 1006 an output unit 1007, a recording unit 1008, a communication unit 1009, and a drive 1010.

The input unit 1006 includes a microphone, a physical button, or the like. The output unit 1007 includes a display, a speaker, or the like. The recording unit 1008 includes a hard disk, a nonvolatile memory, or the like. The communication unit 1009 includes a communication I/F circuit or the like. The drive 1010 drives a removable recording medium 1011 such as a magnetic disk, an optical disk, a magneto-optical disk, and a semiconductor memory.

On the computer 1000 configured as above, the series of above-described processing is executed by operation such that the CPU 1001 loads, for example, a program stored in the recording unit 1008 onto the RAM 1003 via the input/output interface 1005 and the bus 1004 and executes the program.

The program executed by the computer 1000 (CPU 1001) can be stored, for example, in the removable recording medium 1011 as a package medium or the like and be provided. Alternatively, the program can be provided via a wired or wireless transmission medium including a local area network, the Internet, and digital satellite broadcasting.

On the computer 1000, the program can be installed in the recording unit 1008 via the input/output interface 1005, by attaching the removable recording medium 1011 to the drive 1010. In addition, the program can be received at the communication unit 1009 via a wired or wireless transmission medium and be installed in the recording unit 1008. Alternatively, the program can be installed in the ROM 1002 or the recording unit 1008 beforehand.

Note that the program executed by the computer 1000 may be a program processed in time series in an order described in the present description, or can be a program processed in required timing such as being called.

Here, note that in the present description, processing steps describing a program required for causing the computer 1000 to execute various types of processing are not necessarily processed sequentially in an order described in the flowchart. The processing steps may include steps executed in parallel or individually (for example, parallel processing or processing by objects).

In addition, the program can be processed by one computer or can be handled with distributed processing by a plurality of computers. Furthermore, the program can be transferred to a remote computer and be executed.

Furthermore, in the present description, the system represents a set of multiple constituents (devices, modules (parts), or the like). In other words, all the constituents may be in a same housing but they do not have to be in the same housing. Accordingly, a plurality of apparatuses, housed in separate housings, connected via a network can be a system. An apparatus in which a plurality of modules is housed in one housing can also be a system.

Note that embodiments of the present technology are not limited to the above-described embodiments but can be modified in a variety of ways within a scope of the present technology. For example, the present technology can be configured as a form of cloud computing in which one function is shared in cooperation for processing among a plurality of devices via a network.

Moreover, each of steps described in the above flowcharts can be executed on one apparatus or shared by a plurality of apparatuses for processing. Furthermore, in a case where one step includes a plurality of stages of processing, the plurality of stages of processing included in the one step can be executed on one apparatus or can be shared by a plurality of apparatuses.

Note that the present technology can be configured as follows.

(1)

An audio signal reproduction apparatus including:

a reproduction unit that reproduces an audio signal supplied to a speaker installed to be directed to a listening position; and

an adjustment unit that adjusts a delay amount of the audio signal supplied to a target speaker in accordance with an interval of a measurement sound obtained from a picked-up signal with another speaker,

in which the picked-up signal is a measurement sound picked up by a sound pickup apparatus installed at the listening position and is a signal including the measurement sound corresponding to a measurement signal, and

the measurement signal is a signal that causes a plurality of speakers installed to be directed to the listening position to output the measurement sound at a predetermined time interval.

(2)

The audio signal reproduction apparatus according to (1),

in which the adjustment unit adjusts the delay amount of the audio signal in accordance with a distance difference between positions of respective speakers with respect to the listening position.

(3)

The audio signal reproduction apparatus according to (2),

in which the adjustment unit adjusts the delay amount of the audio signal on a basis of a speaker installed at a position farthest from the listening position among the plurality of speakers.

(4)

The audio signal reproduction apparatus according to any of (1) to (3),

in which the audio signal reproduction apparatus is further configured to be connected to the plurality of speakers, and

supply the measurement signal to the plurality of speakers at the time of measurement and supply the audio signal corresponding to the delay amount at the time of reproduction.

(5)

The audio signal reproduction apparatus according to (4),

in which the audio signal reproduction apparatus is further configured to supply, at the time of measurement, the measurement signal to the plurality of speakers after sound pickup by the sound pickup apparatus is started.

(6)

The audio signal reproduction apparatus according to any of (1) to (5),

in which the sound pickup apparatus is a terminal device having a microphone, and

after starting the sound pickup by the microphone, the terminal device supplies the measurement signal to each of the plurality of speakers of the audio signal reproduction apparatus, and requests starting output of the measurement sound from each of the speakers.

(7)

The audio signal reproduction apparatus according to (6),

in which the terminal device

calculates a delay amount of the audio signal on the basis of the picked-up signal obtained by picking up the measurement sound output from the plurality of speakers, and

transmits the calculated delay amount of the audio signal to the audio signal reproduction apparatus.

(8)

The audio signal reproduction apparatus according to any of (1) to (3),

in which the audio signal reproduction apparatus is a speaker installed to be directed to the listening position and is a wireless speaker having a speaker unit, and

supplies the measurement signal to the speaker unit at the time of measurement and supplies the audio signal corresponding to the delay amount to the speaker unit at the time of reproduction.

(9)

The audio signal reproduction apparatus according to (8),

in which the sound pickup apparatus is a terminal device having a microphone,

the terminal device

transmits the measurement signal to each of the plurality of wireless speakers after starting the sound pickup by the microphone, and requests start of the output of the measurement sound from each of the wireless speakers,

calculates the delay amount of the audio signal on the basis of the picked-up signal obtained by picking up the measurement sound output from the plurality of wireless speakers, and

transmits the calculated delay amount of the audio signal to each of the plurality of wireless speakers, and requests reproduction of the audio signal corresponding to the delay amount by each of the wireless speakers.

(10)

The audio signal reproduction apparatus according to any of (1) to (9),

in which the time interval is a time interval exceeding a maximum time lag caused by the distance difference from the listening position to the position of each of the speakers.

(11)

The audio signal reproduction apparatus according to any of (1) to (9),

in which the time interval is a time interval exceeding a predicted value of the distance difference from the listening position to the position of each of the speakers.

(12)

The audio signal reproduction apparatus according to any of (1) to (9),

in which the time interval is either a same time interval for each of the plurality of speakers, or different time intervals corresponding to the predicted value of the distance difference from the listening position to the position of each of the speakers.

(13)

A reproduction method of an audio signal reproduction apparatus including:

a reproduction unit that reproduces an audio signal supplied to a speaker installed to be directed to a listening position;

an adjustment unit that adjusts a delay amount of the audio signal supplied to a target speaker in accordance with an interval of a measurement sound obtained from a picked-up signal with another speaker; and

a step,

in which the picked-up signal is a measurement sound picked up by a sound pickup apparatus installed at the listening position and is a signal including the measurement sound corresponding to a measurement signal, and

the measurement signal is a signal that causes a plurality of speakers installed to be directed to the listening position to output the measurement sound at a predetermined time interval.

(14)

A program causing a computer to function as an audio signal reproduction apparatus including:

a reproduction unit that reproduces an audio signal supplied to a speaker installed to be directed to a listening position; and

an adjustment unit that adjusts a delay amount of the audio signal supplied to a target speaker in accordance with an interval of a measurement sound obtained from a picked-up signal with another speaker,

in which the picked-up signal is a measurement sound picked up by a sound pickup apparatus installed at the listening position and is a signal including the measurement sound corresponding to a measurement signal, and

the measurement signal is a signal that causes a plurality of speakers installed to be directed to the listening position to output the measurement sound at a predetermined time interval.

(15)

A sound pickup apparatus including

a sound pickup unit that picks up a measurement sound corresponding to a measurement signal output from a plurality of speakers installed to be directed to a listening position and obtains a picked-up signal,

in which the measurement signal is a signal that causes the plurality of speakers to output the measurement sound at a predetermined time interval, and

the picked-up signal is a signal including the measurement sound picked up at the listening position.

(16)

The sound pickup apparatus according to (15),

in which the sound pickup apparatus is further configured to, after starting the sound pickup by the sound pickup unit, supply the measurement signal to each of the plurality of speakers of an audio signal reproduction apparatus that reproduces an audio signal and request starting output of the measurement sound from each of the speakers.

(17)

The sound pickup apparatus according to (15) or (16), further including:

a calculation unit that calculates a delay amount of the audio signal on the basis of the picked-up signal obtained by picking up the measurement sound output from the plurality of speakers; and

a transmission unit that transmits the calculated delay amount of the audio signal to the audio signal reproduction apparatus.

(18)

The sound pickup apparatus according to any of (15) to (17),

in which the sound pickup unit is a microphone, and

the sound pickup apparatus is a terminal device including the microphone.

(19)

A sound pickup method of a sound pickup apparatus, the method including a step of, by a sound pickup apparatus, picking up a measurement sound corresponding to a measurement signal output from a plurality of speakers installed to be directed to a listening position and thereby obtaining a picked-up signal,

in which the measurement signal is a signal that causes the plurality of speakers to output the measurement sound at a predetermined time interval, and the picked-up signal is a signal including the measurement sound picked up at the listening position.

(20)

A program causing a computer to function as a sound pickup apparatus including

a sound pickup unit that picks up a measurement sound corresponding to a measurement signal output from a plurality of speakers installed to be directed to a listening position and obtains a picked-up signal,

in which the measurement signal is a signal that causes the plurality of speakers to output the measurement sound at a predetermined time interval, and

the picked-up signal is a signal including the measurement sound picked up at the listening position.

### REFERENCE SIGNS LIST

1 Multi-channel audio system
2 Wireless speaker system
10 Mobile terminal device
20 Speaker
20-C Center speaker
20-L Front L speaker
20-R Front R speaker
20-SL Surround L speaker
20-SR Surround R speaker
21 Wireless speaker
21-C Center wireless speaker
21-L Front L wireless speaker
21-R Front R wireless speaker
21-SL Surround L wireless speaker
21-SR Surround R wireless speaker
30 Audio signal reproduction apparatus
40 External signal source
100 Processing unit
101 Memory
103 Microphone
106 Transmission unit
111 Distance difference calculation unit
112 Delay amount calculation unit
200 Controller
201 Reception unit
202 Transmission unit
203 Decoding unit
204 Reproduction buffer
205 Signal amplifier
206 Speaker unit
300 Controller
301 Memory
302 Reception unit
303 Decoding unit
304-1 to 304-5 Signal amplifier
305-1 to 305-5 Delay memory
1000 Computer
1001 CPU

1. An audio signal reproduction apparatus comprising:
a reproduction unit that reproduces an audio signal supplied to a speaker installed to be directed to a listening position; and
an adjustment unit that adjusts a delay amount of the audio signal supplied to a target speaker in accordance with an interval of a measurement sound obtained from a picked-up signal with another speaker,
wherein the picked-up signal is a measurement sound picked up by a sound pickup apparatus installed at the listening position and is a signal including the measurement sound corresponding to a measurement signal, and
the measurement signal is a signal that causes a plurality of speakers installed to be directed to the listening position to output the measurement sound at a predetermined time interval.

2. The audio signal reproduction apparatus according to claim 1,
wherein the adjustment unit adjusts the delay amount of the audio signal in accordance with a distance difference between positions of respective speakers with respect to the listening position.

3. The audio signal reproduction apparatus according to claim 2,
wherein the adjustment unit adjusts the delay amount of the audio signal on a basis of a speaker installed at a position farthest from the listening position among the plurality of speakers.

4. The audio signal reproduction apparatus according to claim 1,
wherein the audio signal reproduction apparatus is further configured to be connected to the plurality of speakers, and
supply the measurement signal to the plurality of speakers at the time of measurement and supply the audio signal corresponding to the delay amount at the time of reproduction.

5. The audio signal reproduction apparatus according to claim 4,
wherein the audio signal reproduction apparatus is further configured to supply, at the time of measurement, the measurement signal to the plurality of speakers after sound pickup by the sound pickup apparatus is started.

6. The audio signal reproduction apparatus according to claim 1,
wherein the sound pickup apparatus is a terminal device having a microphone, and
after starting the sound pickup by the microphone, the terminal device supplies the measurement signal to each of the plurality of speakers of the audio signal reproduction apparatus, and requests starting output of the measurement sound from each of the speakers.

7. The audio signal reproduction apparatus according to claim 6,
wherein the terminal device
calculates a delay amount of the audio signal on a basis of the picked-up signal obtained by picking up the measurement sound output from the plurality of speakers, and
transmits the calculated delay amount of the audio signal to the audio signal reproduction apparatus.

8. The audio signal reproduction apparatus according to claim 1,
wherein the audio signal reproduction apparatus is a speaker installed to be directed to the listening position and is a wireless speaker having a speaker unit, and
supplies the measurement signal to the speaker unit at the time of measurement and supplies the audio signal corresponding to the delay amount to the speaker unit at the time of reproduction.

9. The audio signal reproduction apparatus according to claim 8,
wherein the sound pickup apparatus is a terminal device having a microphone,
the terminal device
transmits the measurement signal to each of the plurality of wireless speakers after starting the sound pickup by the microphone, and requests start of the output of the measurement sound from each of the wireless speakers,
calculates the delay amount of the audio signal on a basis of the picked-up signal obtained by picking up the measurement sound output from the plurality of wireless speakers, and
transmits the calculated delay amount of the audio signal to each of the plurality of wireless speakers, and requests reproduction of the audio signal corresponding to the delay amount by each of the wireless speakers.

10. The audio signal reproduction apparatus according to claim 2,
wherein the time interval is a time interval exceeding a maximum time lag caused by the distance difference from the listening position to the position of each of the speakers.

11. The audio signal reproduction apparatus according to claim 2,
wherein the time interval is a time interval exceeding a predicted value of the distance difference from the listening position to the position of each of the speakers.

12. The audio signal reproduction apparatus according to claim 2,
wherein the time interval is either a same time interval for each of the plurality of speakers, or different time intervals corresponding to the predicted value of the distance difference from the listening position to the position of each of the speakers.

13. A reproduction method of an audio signal reproduction apparatus including:
a reproduction unit that reproduces an audio signal supplied to a speaker installed to be directed to a listening position;
an adjustment unit that adjusts a delay amount of the audio signal supplied to a target speaker in accordance with an interval of a measurement sound obtained from a picked-up signal with another speaker; and
a step,
wherein the picked-up signal is a measurement sound picked up by a sound pickup apparatus installed at the listening position and is a signal including the measurement sound corresponding to a measurement signal, and
the measurement signal is a signal that causes a plurality of speakers installed to be directed to the listening position to output the measurement sound at a predetermined time interval.

14. A program causing a computer to function as an audio signal reproduction apparatus including:
a reproduction unit that reproduces an audio signal supplied to a speaker installed to be directed to a listening position; and
an adjustment unit that adjusts a delay amount of the audio signal supplied to a target speaker in accordance with an interval of a measurement sound obtained from a picked-up signal with another speaker,
wherein the picked-up signal is a measurement sound picked up by a sound pickup apparatus installed to be directed to the listening position and is a signal including the measurement sound corresponding to a measurement signal, and
the measurement signal is a signal that causes a plurality of speakers installed to be directed to the listening position to output the measurement sound at a predetermined time interval.

15. A sound pickup apparatus comprising
a sound pickup unit that picks up a measurement sound corresponding to a measurement signal output from a plurality of speakers installed to be directed to a listening position and obtains a picked-up signal,
wherein the measurement signal is a signal that causes the plurality of speakers to output the measurement sound at a predetermined time interval, and
the picked-up signal is a signal including the measurement sound picked up at the listening position.

16. The sound pickup apparatus according to claim 15,
wherein the sound pickup apparatus supplies, after starting the sound pickup by the sound pickup unit, the measurement signal to each of the plurality of speakers of an audio signal reproduction apparatus that reproduces an audio signal and requests starting output of the measurement sound from each of the speakers.

17. The sound pickup apparatus according to claim 16, further comprising:
a calculation unit that calculates a delay amount of the audio signal on a basis of the picked-up signal obtained by picking up the measurement sound output from the plurality of speakers; and
a transmission unit that transmits the calculated delay amount of the audio signal to the audio signal reproduction apparatus.

18. The sound pickup apparatus according to claim 15,
wherein the sound pickup unit is a microphone, and
the sound pickup apparatus is a terminal device including the microphone.

19. A sound pickup method of a sound pickup apparatus, the method comprising
a step of, by a sound pickup apparatus, picking up a measurement sound corresponding to a measurement signal output from a plurality of speakers installed to be directed to a listening position and obtaining a picked-up signal,
wherein the measurement signal is a signal that causes the plurality of speakers to output the measurement sound at a predetermined time interval, and
the picked-up signal is a signal including the measurement sound picked up at the listening position.

20. A program causing a computer to function as a sound pickup apparatus including
a sound pickup unit that picks up a measurement sound corresponding to a measurement signal output from a plurality of speakers installed to be directed to a listening position and obtains a picked-up signal,
wherein the measurement signal is a signal that causes the plurality of speakers to output the measurement sound at a predetermined time interval, and
the picked-up signal is a signal including the measurement sound picked up at the listening position.
